(19) United States
(12) Patent Application Publication
(10) Pub. No.: US 2026/0064095 A1
(43) Pub. Date: Mar. 5, 2026

(54) Test System and Method for Controlling Test System

(71) Applicant: SAGINOMIYA SEISAKUSHO, INC., Tokyo (JP)

(72) Inventors: Eisei In, Sayama-shi (JP); Tomohiro Hosaka, Sayama-shi (JP); Hirofumi Kawanishi, Sayama-shi (JP); Ayumu Enomoto, Sayama-shi (JP)

(21) Appl. No.: 19/105,990

(22) PCT Filed: Jul. 5, 2023
(86) PCT No.: PCT/JP2023/024982

§ 371 Date: Feb. 24, 2025

(30) Foreign Application Priority Data
Sep. 2, 2022 (JP) 2022-140118

(51) Int. Cl. G05B 17/02; G01M 17/04

(52) U.S. Cl. CPC G05B 17/02; G01M 17/04; G05B 2219/23446

(57) ABSTRACT

A test system is provided which includes an actuator that actuates a test piece, a virtual model that operates in association with the test piece, a controller that controls the actuator, a computing device that computes the virtual model, and an inverse transfer function correcting unit that corrects a signal from the virtual model with a proper inverse transfer function that is determined based on a transfer function of a system including communication units between the test piece and the actuator and between the actuator and the controller and a communication unit between the computing device and the controller. The controller controls the actuator based on the signal corrected by the inverse transfer function correcting unit.

### CROSS-REFERENCE TO RELATED APPLICATIONS

This application is the United States national phase of International Patent Application No. PCT/JP2023/024982, filed Jul. 5, 2023, and claims priority to Japanese Patent Application No. 2022-140118, filed Sep. 2, 2022, the disclosures of which are hereby incorporated by reference in their entireties.

### BACKGROUND OF THE INVENTION

### Field of the Invention

The present invention relates to a test system and a method for controlling the test system. In particular, it relates to a test system that uses a virtual model and a test piece as a part of a real machine.

### Description of Related Art

By using such a system to develop a new-model vehicle or the like, the cost and time required for development can be reduced. In this test system, for example, the real thing may be substituted for a part or assembly that is difficult to model and used as a test piece, or a part of a real prototype machine or the like may be used as a test piece. The verification of the characteristics of the test piece or the verification of a model excluding the test piece is conducted by so-called Hardware In the Loop Simulation (HILS).

With such a test system, some error can occur between the behavior of the real machine and the request from the model. With regard to the correction of such an error, Patent Literature 1 discloses a trajectory data correcting device that is provided in an NC machine tool or the like and eliminates a contour cutting error caused by servo characteristics that occurs in a numerical controller that achieves contour cutting. In the contour error correction disclosed in Patent Literature 1, for a known command value, command data having an error corrected in advance with an inverse transfer function correcting unit is generated, and the command data is input to the controller. Patent Literature 2 discloses a test system that uses a model including a tire, a lower mass and an upper mass and a test piece formed by a shock absorber, and performs a load test by an actuator applying a load to the shock absorber based on a signal from the model. In Patent Literature 2, the control waveform used by the controller is corrected and updated so as to decrease the error (response lag) between the control waveform and the reference waveform from the model. However, the input waveform to the model is constant (a time waveform over several tens of seconds), and upon completion of each test, the output of the model (that is, the input to the load device) is compared with the previous output, and the error is corrected by using an inverse transfer function offline. The same test is performed using the corrected data until the error is sufficiently small, and then the formal verification test is then performed.

### CITATION LIST

### Patent Literature

[Patent Literature 1] Japanese Patent Laid-Open No. 63-233402
[Patent Literature 2] Japanese Patent Laid-Open No. 2004-53452

### SUMMARY OF THE INVENTION

### Technical Problem

With the HILS test system, the input signal to the model changes in real time, and the input from the model to the load device (controller) and the feedback signal from the load device to the model also change in real time. In this way, the feedback from the model and the feedback from the test piece constituted by the real load device form one closed loop and interact with each other in real time. If the feedback signal from the load device lags because of its frequency characteristics or the feedback signals have different magnitudes, the result may deviate from the true characteristics, or the simulation may diverge and the verification may be unable to be achieved. In this regard, according to Patent Literatures 1 and 2, a correction calculation based on an inverse transfer function needs to be performed in advance, and the problem arising from the lag because of the load device cannot be solved in real time. According to Patent Literature 1, since no model is involved, the command signal is determined in advance and does not need to be computed in real time.

According to Patent Literature 2, during the simulation, the output signal from the model at the current time is not used, and the signal corrected in the previous step is used, so that the system is a closed loop. When one simulation ends, a signal for the subsequent step is generated offline. Thus, the system is a non-real time HILS system that cannot be used for HILS verification in which the input signal to the model changes in real time. That is, in Patent Literature 2, an inverse transfer function that allows accurate real-time calculation in the time domain is not used, so that there is a disadvantage that only a predetermined signal can be corrected.

An object of the present invention is to provide a test system and a control method for the test system that can eliminate a response lag of a load system caused by an actuator that actuates a test piece or the like and enable more accurate real-time simulation involving a model and a real machine.

### Solution to Problem

To solve the problem described above, a test system according to an aspect of the present invention includes a test piece as a part of a real machine that is to be tested, an actuator that actuates the test piece, a virtual model that operates in association with the test piece, a controller that controls the actuator, a computing device that computes the virtual model, and an inverse transfer function correcting unit that corrects a signal from the virtual model with a proper inverse transfer function that is determined based on a transfer function of a system including communication units between the test piece and the actuator and between the actuator and the controller and a communication unit between the computing device and the controller, and the controller controls the actuator based on the signal corrected by the inverse transfer function correcting unit.

A control method for a test system according to an aspect of the present invention is a control method for a test system that includes a test piece as a part of a real machine that is to be tested, an actuator that actuates the test piece, a virtual model that operates in association with the test piece, a controller that controls the actuator, and a computing device that computes the virtual model, and the control method includes a step of correcting a signal from the virtual model with a proper inverse transfer function that is determined based on a transfer function of a system including communication units between the test piece and the actuator and between the actuator and the controller and a communication unit between the computing device and the controller, and a step of controlling the actuator based on the signal corrected in the inverse transfer function correcting step.

### Advantageous Effect of Invention

According to the aspects described above, the test system can eliminate a response lag of a load system caused by an actuator that actuates a test piece and enable more accurate real-time simulation involving a model and a real machine.

### BRIEF DESCRIPTION OF THE DRAWINGS

FIG. 1(a) is a functional block diagram showing a well-known test system that does not perform correction based on a transfer function. FIG. 1(b) is a functional block diagram showing a test system that performs correction with an inverse transfer function according to an embodiment.

FIG. 2 is a diagram for illustrating a virtual model shown in FIG. 1.

FIG. 3 is a flowchart for illustrating a method of generating an inverse transfer function used in an inverse transfer function correcting unit in FIG. 1.

FIG. 4 is a diagram showing an example measurement of a transfer function of a load device including an output unit of a computing device, a controller, an actuator and a test piece shown in FIG. 1(a).

FIGS. 5(a) and (b) are graphs showing transfer characteristics approximated as a third-order polynomial and measured transfer characteristics (FIG. 4) for comparison, FIG. 5(a) showing the gain, and FIG. 5(b) showing the phase.

FIGS. 6(a) and (b) are diagrams showing a theoretical inverse transfer function and an inverse transfer function generated by approximation in the embodiment for comparison, FIG. 6(a) showing the gain, and FIG. 6(b) showing the phase.

FIGS. 7(a) and (b) are diagrams showing, for comparison, an input signal to the controller for the actuator that is not corrected by the inverse transfer function correcting unit and an input signal to the controller for the actuator that has passed through the inverse transfer function correcting unit, and FIG. 7(b) is an enlarged diagram of a part of FIG. 7(a).

FIGS. 8(a) to (i) are diagrams showing an example in which the test system according to the embodiment is applied to HILS test of a vehicle. FIG. 8(a) is a displacement input to the virtual model in FIGS. 1(a) and 1(b) from a road surface shown in FIG. 2. FIGS. 8(b) and 8(f) show calculation results of input signals (the difference in displacement between Y1 and Y2 calculated by the model in FIG. 2) to the load device in FIGS. 1(a) and 1(b), and FIGS. 8(c) and 8(g) show loads of the test piece in FIGS. 1(a) and 1(b) fed back from the test piece to the virtual model. FIGS. 8(d), 8(e), 8(h) and 8(i) are enlarged diagrams of FIGS. 8(b), 8(c), 8(f) and 8(g), respectively.

### DESCRIPTION OF THE INVENTION

In the following, an embodiment of the present invention will be described with reference to the drawings. The drawings used for describing the embodiment are intended to describe a configuration of the embodiment, positional relationships between parts included in the configuration, and operations, effects and technical principles of the embodiment, and are not intended to limit the present invention to the specific configuration of the embodiment.

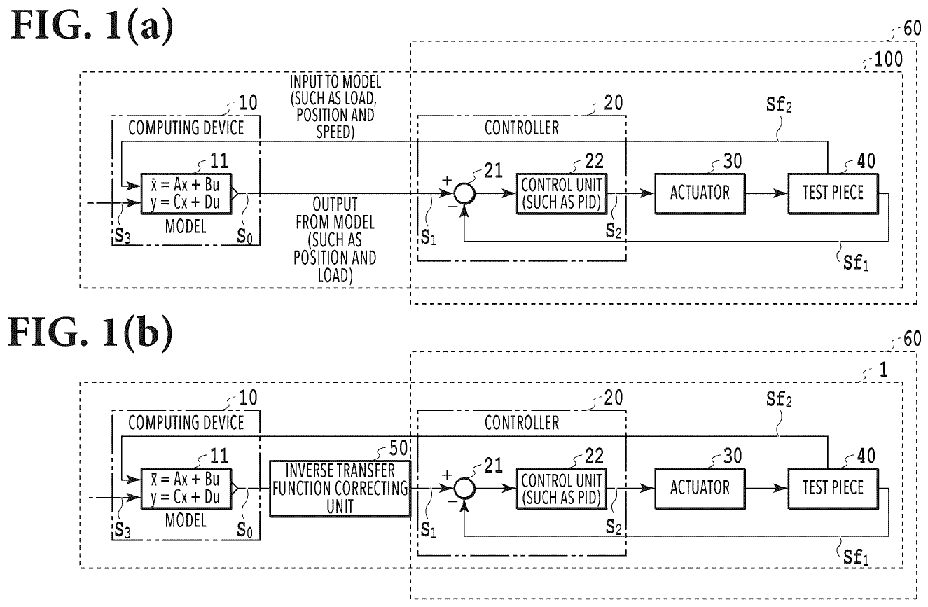

FIGS. 1(a) and 1(b) are functional block diagrams for illustrating a test system according to this embodiment. FIG. 1(a) shows a test system 100 that does not perform correction based on a transfer function as a comparative example, and FIG. 1(b) shows a test system 1 that performs correction with an inverse transfer function according to this embodiment. Both the test system 100 according to the comparative example and the test system 1 according to this embodiment include a test piece 40, which is a part of a real machine to be tested, an actuator 30 that actuates the test piece 40, a virtual model 11 that operates in association with the test piece, a controller 20 that controls the actuator 30, and a computing device 10 that performs a computation involved with the virtual model 11. The controller 20, the actuator 30 and the test piece 40 form a load device (system) 60.

The test system 1 differs from the test system 100 according to the comparative example in that the test system 1 includes an inverse transfer function correcting unit 50 between the virtual model 11 and the controller 20, and the inverse transfer function correcting unit 50 corrects a signal from the virtual model 11. An inverse transfer function retained as a feature in the inverse transfer function correcting unit 50 is a proper inverse transfer function that is determined based on a transfer function in a system including communication units between the test piece 40 and the actuator 30 and between the actuator 30 and the controller 20 and a communication unit between the computing device 10 and the controller 20. Although the communication units between the test piece 40 and the actuator 30 and between the actuator 30 and the controller 20 and the communication unit between the computing device 10 and the controller 20 are not shown in the drawings, it is obvious that there are communication units between the test piece 40 and the actuator 30 and between the actuator 30 and the controller 20 since signals S₁ and S₂ are sequentially transmitted from the controller 20 to the actuator 30 and the test piece 40. It is also obvious that there is a communication unit between the computing device 10 and the controller 20 since signals S₀, S₁ and S₂ are sequentially transmitted from the computing device 10 to the controller 20.

The inverse transfer function retained as a feature in the inverse transfer function correcting unit 50 is basically an inverse transfer function of a transfer function that holds between the signal S₀ output from the virtual model 11 and a signal Sf₁ that indicates a displacement of the test piece 40 driven by the actuator 30 in the test system 100 shown in FIG. 1(a). The inverse transfer function is also an approximation of an inverse transfer function determined from the above-described transfer function of the test system 100 as a proper inverse transfer function.

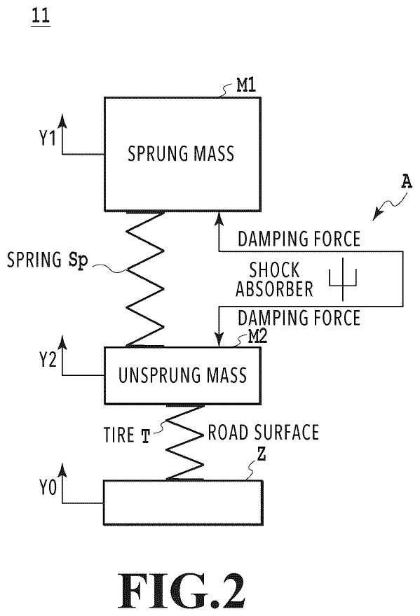

The test systems 1 and 100 relate to a test of a suspension including a tire of a vehicle. As a shock absorber A (FIG. 2), a real shock absorber as the test piece 40 is used instead of the virtual model 11, and the shock absorber A is actuated by the actuator 30 controlled by the controller 20. The other components than the shock absorber A, specifically, a spring, a tire under the spring, and a vehicle body on the spring, are implemented by the virtual model 11. The virtual model 11 is implemented in the real-time computing device 10 capable of high-speed computing, and the operation of the virtual model 11 is achieved by the computing device 10. A signal S₃ input to the virtual model 11 indicates a displacement of the tire caused by irregularities on a road surface Z during traveling of the vehicle. The displacement is generated by another road surface model (not shown) in the computing device 10. Furthermore, descriptions of the virtual model 11 shown in FIGS. 1(a) and 1(b) are intended to provide schematic expressions of the virtual model 11 and are not intended to show actual expressions.

FIG. 2 is a diagram showing a physical system of the virtual model 11 shown in FIGS. 1(a) and 1(b). In the virtual model 11, a sprung mass M1 corresponds to the mass of the vehicle body on a spring Sp, and an unsprung mass M2 corresponds to the mass under the spring Sp, including an axle and a tire T. The shock absorber A is disposed between the sprung mass M1 and the unsprung mass M2. A lower surface of the tire T is in contact with the road surface Z, a position Y0 of the lower end of the tire T varies because of the irregularities on the road surface Z during traveling of the vehicle, and an input to the shock absorber A is the difference in displacement between a position Y2 and a position Y1, where the position Y1 is the position of the sprung mass M1, and the position Y2 is the position of the unsprung mass M2. An output of the shock absorber A is a load, and the load acts on the unsprung mass M1 and the sprung mass M1.

With regard to the shock absorber A, in HILS using a real machine instead of a theoretical model, the difference between the position Y2 and the position Y1 is input to the load device 60, the load produced by the shock absorber A driven by the load device 60 is fed back to the virtual model 11 as with the shock absorber A implemented by the virtual model 11, and then the computation of the virtual model 11 is performed.

Referring back to FIGS. 1(a) and 1(b), the computing device 10 performs sampling at regular time intervals (every 0.5 ms, for example), and calculates the displacements (Y1, Y2) of the masses in the virtual model 11 in response to the input Y0 from the road surface Z and the signal S₀ (Y1-Y2) that indicates the displacement of the shock absorber A.

The controller 20 includes a comparison unit 21 and a control unit 22. The comparison unit 21 computes the difference between the signal S₀ (signal S₁: the absorber displacement Y2-Y1 described above) received from the model 11 (via the inverse transfer function unit 50 in FIG. 1(b)) and the signal Sf₁ fed back from the test piece 40, and outputs the difference to the control unit 22. Based on the difference signal from the comparison unit 21, the control unit 22 performs PID control, for example, to control the amount of actuation of the actuator 30, for example. Note that the controller 20 may be an electronic control unit (ECU) in the HILS test.

According to the signal S₂ from the control unit 22, the actuator 30 actuates the test piece 40 (shock absorber A) to achieve the operation (displacement Y2-Y1) relating to the test evaluation item. The actuator 30 may be a hydraulic actuator or a motor-driven actuator, for example. The test piece 40 operates by being driven by the actuator 30. The operation is detected by a predetermined sensor (not shown), and the detection signal Sf₁ is output to the comparison unit 21 and used for controlling the actuator. A signal Sf₂ (load) is output to the virtual model 11 and used for calculation in a subsequent step.

When the shock absorber A is not implemented by a real machine and is completely simulated with a model, the displacement S₀ of the absorber calculated on the model is input to the modelled absorber at the same time, and the computation in a subsequent step is performed using a load calculated by the modelled absorber. However, in the HILS system that uses a real shock absorber A, a lag and an amplitude variation occur between the signal Sf₁ indicating the displacement of the shock absorber A and the signal S₀ because of the controller 20 and the actuator 30. Therefore, the load signal generated by the real shock absorber A also lags behind what the load signal would otherwise be, and accurate simulation cannot be achieved. Depending on the conditions, the simulation may diverge.

In the test system 1 according to this embodiment, the inverse transfer function correcting unit 50 serving as the inverse transfer function can correct the signal S₀ from the virtual model 11, thereby advancing the signal S₀ by the same amount as the amount by which the signal S₁ input to the comparison unit 21 lags behind the signal S₀ because of the load device 60 including the controller 20 and the actuator 30. Therefore, the test system 1 can solve the problem that the signal Sf₁ indicating the displacement of the shock absorber A temporally lags behind the signal S₀ from the virtual model 11 because of the actuator 30 and the like, and achieve more accurate simulation.

Specifically, in the system in FIG. 1(a), S₀=S₁, and the signal Sf₁ lags behind the signal S₁ by δt seconds, for example. Therefore, the signal Sf₂ also lags behind the simulation purely based on the model by δt seconds. In FIG. 1(b), the signal S₁ is advanced with respect to the signal S₀ by δt seconds through correction by the inverse transfer function correcting unit 50. The relationship between the signal Sf₁ and the signal S₁ remains unchanged, so that the signal Sf₁ lags by δt seconds behind the signal S₁, which is advanced with respect to the signal S₀ by δt seconds. Therefore, the lag of the signal Sf₁ with respect to the signal S₀ is eliminated, and the lag of the signal Sf₂ indicating the load input to the virtual model 11 is also eliminated.

Note that although FIG. 1(b) shows the inverse transfer function correcting unit 50 disposed between the computing device 10 and the controller 20 in the load device 60 for the purpose of description, the inverse transfer function correcting unit 50 is implemented in the computing device 10 or the controller 20 in the actual implementation.

### (Generation of Inverse Transfer Function)

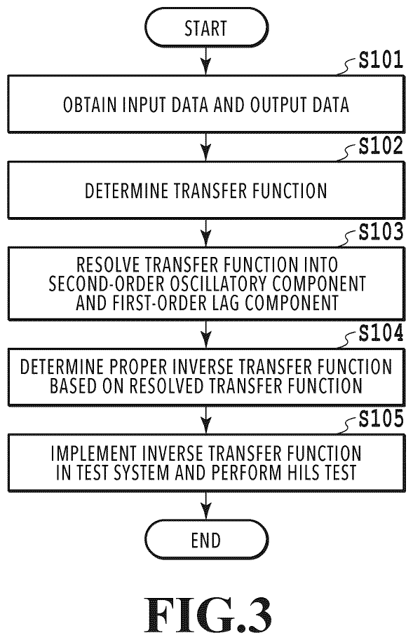

FIG. 3 is a flowchart showing a process of generating an inverse transfer function in the inverse transfer function correcting unit 50 in FIGS. 1(a) and (b). This process is performed before the operation of the test system 1 in FIGS. 1(a) and (b).

First, in step S101, while the controller 20 is yet to be connected to the virtual model 11, the controller 20 input a signal S₂ indicating input data for each of a plurality of frequencies to the actuator 30 to provide the test piece 40 (shock absorber) with an oscillatory input, and obtains a displacement Sf₁ of the shock absorber A at that time. The oscillation can be provided by sinusoidal sweep excitation or random excitation in a predetermined frequency range. The predetermined frequency range is determined based on the characteristics of the test piece 40 to be simulated. In the case of the absorber of a vehicle, the frequency range may be higher than 0 Hz and up to 100 Hz, for example.

Table 1 below shows an example of actual measurement in this embodiment. Table 1 shows the gain and phase (deg) of the signal Sf₁ with respect to the signal S₀ on an oscillation frequency basis. The gain is shown in terms of both dB and actual number. The gain is an amplitude ratio of the signal Sf₁, and a negative phase means a temporal lag.

TABLE 1

| | | | | gain in |
|---|---|---|---|---|
| No | frequency(Hz) | gain(dB) | phase(deg) | actual number |
| 1 | 1.342 | 0.101 | −2.929 | 1.0117 |
| 2 | 3.117 | 0.065 | −5.075 | 1.0076 |
| 3 | 4.817 | 0.046 | −7.766 | 1.0053 |
| 4 | 4.817 | 0.046 | −7.766 | 1.0053 |
| 5 | 5.467 | 0.043 | −8.720 | 1.0050 |
| 6 | 6.575 | 0.023 | −10.446 | 1.0027 |
| 7 | 7.521 | 0.010 | −11.945 | 1.0011 |
| 8 | 8.361 | 0.005 | −13.305 | 1.0006 |
| 9 | 9.123 | −0.016 | −14.603 | 0.9981 |
| 10 | 10.159 | −0.020 | −16.147 | 0.9977 |
| . | . | . | . | . |
| . | . | . | . | . |
| . | . | . | . | . |

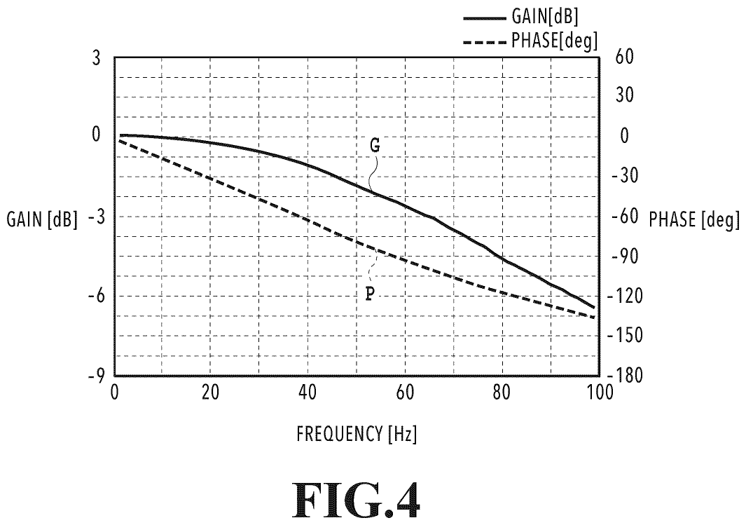

FIG. 4 is a Bode diagram showing transfer functions represented by the measurement data in Table 1. In FIG. 4, G denotes frequency characteristics of the gain, and P denotes frequency characteristics of the phase.

The measurement data in Table 1 above is expressed as a complex number as shown in Table 2 below. Specifically, the relationship between the gain and the phase in Table 1 above can be expressed as a complex number as follows:

$$G ( j {ω}_{k} ) = A {e}^{j φ} = A ( cos φ + j sin φ ) = A cos φ + jA sin φ = {R}_{m} + {jI}_{m}$$

In this formula, A denotes the gain (in actual number), and q denotes the phase (deg). Therefore, the values in Table 1 are transformed into the values in Table 2 according to the above formula.

TABLE 2

| | | | imaginary |
|---|---|---|---|
| No | frequency(Hz) | real part(Rm) | part(Im) |
| 1 | 1.342 | 1.0104 | −0.0517 |
| 2 | 3.117 | 1.0036 | −0.0891 |
| 3 | 4.817 | 0.9961 | −0.1357 |
| 4 | 4.817 | 0.9961 | −0.1358 |
| 5 | 5.467 | 0.9934 | −0.1524 |
| 6 | 6.575 | 0.9861 | −0.1818 |
| 7 | 7.521 | 0.9795 | −0.2072 |
| 8 | 8.361 | 0.9738 | −0.2303 |
| 9 | 9.123 | 0.9663 | −0.2500 |
| 10 | 10.159 | 0.9584 | −0.2775 |
| . | . | . | . |
| . | . | . | . |
| . | . | . | . |

In step S102, an approximate mathematical expression of the transfer function is then determined using the transfer function data expressed as discrete numerical values obtained in step S101.

### (General Formula of Transfer Function)

To determine a transfer function appropriate to the measurement data, first, a transfer function expressed as a general formula is determined as a reference for comparison. The general formula of the transfer function can be expressed as the following formula (1).

$$\begin{matrix}[ Formula 1 ] & \\ G ( s ) = \frac{{b}_{n - 1} {s}^{n - 1} + … + {b}_{1} {s}^{1} + {b}_{0}}{{a}_{n} {s}^{n} + {a}_{n - 1} {s}^{n - 1} + … + {a}_{1} {s}^{1} + 1} & formula ( 1 )\end{matrix}$$

In the system using the actuator according to this embodiment, the above formula (1) can be empirically approximated as the following formula with a numerator of 1.

$$\begin{matrix}[ Formula 2 ] & \\ G ( s ) = \frac{1}{{a}_{n} {s}^{n} + {a}_{n - 1} {s}^{n - 1} + … + {a}_{1} {s}^{1} + 1} & formula ( 2 )\end{matrix}$$

The formula (2) is expressed as a complex number as follows.

$$\begin{matrix}[ Formula 3 ] & \\ G ( j ω ) = \frac{1}{{{a}_{n} ( j ω )}^{n} + {{a}_{n - 1} ( j ω )}^{n - 1} + … + {{a}_{1} ( j ω )}^{1} + 1} = \frac{1}{{R}_{e} + {jI}_{e}} = \frac{{R}_{e} - {jI}_{e}}{{R}_{e}^{2} + {I}_{e}^{2}} = \frac{{R}_{e}}{{R}_{e}^{2} + {I}_{e}^{2}} - j \frac{{I}_{e}}{{R}_{e}^{2} + {I}_{e}^{2}} = {R}_{e} {A}_{e}^{2} - j {I}_{e} {A}_{e}^{2} & formula ( 3 )\end{matrix}$$

In this formula,

$$\begin{matrix}[ Formula 4 ] & \\ Ae = \frac{{R}_{e}}{\sqrt{{R}_{e}^{2} + {I}_{e}^{2}}} & \end{matrix}$$

In the formula (3), when n is even,

$${{{R}_{e} = {{a}_{n} ( j ω )}^{n} + {{a}_{n - 2} ( j ω )}^{n - 2} + … - {a}_{2} {ω}^{2} + 1 = [ ( j ω ) )}^{n} , {( j ω )}^{n - 2} , … , - {ω}^{2} ] [ {a}_{n} , {a}_{n - 2} , … , {a}_{2} ]}^{′} + 1 = {A}_{RE} {a}_{re} + 1 \qquad formula ( 4 )$$

$${{I}_{e} = {j}^{n - 2} {a}_{n - 1} {ω}^{n - 1} + {j}^{n - 4} {a}_{n - 3} {ω}^{n - 3} + … + {a}_{1} ω = ( {j}^{n - 2} {ω}^{n - 1} , {j}^{n - 4} {ω}^{n - 3} , … , ω ] [ {a}_{n - 1} , {a}_{n - 3} , … , {a}_{1} ]}^{′} = {A}_{IM} {a}_{im} \qquad formula ( 5 )$$

In the formula (3), when n is odd,

$${R}_{e} = {{a}_{n - 1} ( j ω )}^{n - 1} + {{a}_{n - 3} ( j ω )}^{n - 3} + … - {a}_{2} {ω}^{2} + 1 = {[ {( j ω )}^{n - 1} , {( j ω )}^{n - 3} , … , - {ω}^{2} ] [ {a}_{n - 1} , {a}_{n - 3} , … , {a}_{2} ]}^{′} + 1 = {A}_{RE} {a}_{re} + 1 \qquad formula ( 6 )$$

$${I}_{e} = {j}^{n - 1} {a}_{n} {ω}^{n} + {j}^{n - 3} {a}_{n - 2} {ω}^{n - 2} + … + {a}_{1} ω = {[ {j}^{n - 1} {ω}^{n} , {j}^{n - 3} {ω}^{n - 2} , … , ω ] [ {a}_{n} , {a}_{n - 2} , … , {a}_{1} ]}^{′} = {A}_{IM} {a}_{im} \qquad formula ( 7 )$$

In the formulas (4) to (7) above, all the indices of the imaginary code j are even, so that the calculation result is [−1] or [1]. Here, A_{RE}aᵣₑ and A_{IM}aᵢₘ are products of matrices. A_{RE} and A_{IM} can be calculated if the angular frequency ω is known.

(Transfer Function based on Measurement Data)

Next, a transfer function based on the measurement data is determined by comparison between the measurement data and the general formula of the transfer function determined above.

The measurement data shown in Table 2 is expressed as a complex number as follows.

$$G ( j {ω}_{k} ) = {Ae}^{j φ} = A ( cos φ + j sin φ ) = A cos φ + jA sin φ = {R}_{m} + {jI}_{m} \qquad formula ( 8 )$$

On the other hand, the complex representation of the formula (2) is as follows.

$$\begin{matrix}[ Formula 5 ] & \\ G ( j ω ) = \frac{{R}_{e}}{{R}_{e}^{2} + {I}_{e}^{2}} - j \frac{{I}_{e}}{{R}_{e}^{2} + {I}_{e}^{2}} = {R}_{e} {A}_{e}^{2} - j {I}_{e} {A}_{e}^{2} & formula ( 9 )\end{matrix}$$

Comparison of the formulas (8) and (9) results in the formulas (10) and (11).

$$\begin{matrix}[ Formula 6 ] & \\ {R}_{e} = {R}_{m} / {A}_{e}^{2} & formula ( 10 )\end{matrix}$$

$$\begin{matrix}[ Formula 7 ] & \\ {I}_{e} = - {I}_{m} / {A}_{e}^{2} & formula ( 11 )\end{matrix}$$

Here, by approximating the gain Ae in these formulas as the gain A in the measurement data, the formulas (10) and (11) are expressed as the formulas (12) and (13), respectively.

$$\begin{matrix}[ Formula 8 ] & \\ {R}_{e} = {R}_{m} / {A}^{2} & formula ( 12 )\end{matrix}$$

$$\begin{matrix}[ Formula 9 ] & \\ {I}_{e} = - {I}_{m} / {A}^{2} & formula ( 13 )\end{matrix}$$

In the formulas (12) and (13), Rₘ and Iₘ for each frequency are obtained from the measurement data, so that the right-hand sides of the formulas (12) and (13) are known. Furthermore, by subtracting the formulas (4) to (7) into the left-hand sides of the formulas (12) and (13), the formulas (12) and (13) are reduced to the following formulas (14) and (15), respectively.

$${A}_{RE} {a}_{re} = {B}_{RE} \qquad formula ( 14 )$$

$${A}_{IM} {a}_{im} = {B}_{IM} \qquad formula ( 15 )$$

In the formulas (14) and (15), B_{RE} and B_{IM} in the right-hand sides are expressed as matrices and therefore are groups of measurement data. When these are plotted, by determining A_{RE}aᵣₑ and A_{IM}aᵢₘ in the left-hand sides that are on the curves of the plots by the least squares method, aᵣₑ and aᵢₘ, which are coefficients in the formula (2), can be determined based on the measurement data.

When the formula (2) is a third-order approximation for n=3, the following formula (16) results.

$$\begin{matrix}[ Formula 10 ] & \\ G ( s ) = \frac{1}{{a}_{3} {s}^{3} + {a}_{2} {s}^{2} + {a}_{1} {s}^{1} + 1} & formula ( 16 )\end{matrix}$$

That is,

$${A}_{RE} = [ - {ω}^{2} ] {a}_{re} = [ {a}_{2} ]$$

$${A}_{IM} = [ - {ω}^{3} , ω ] {a}_{re} = [ {a}_{3} , {a}_{1} ]$$

In the case of the example measurement in Table 1, a1, a2, and a3 are determined as follows.

$${a}_{3} = 4.634 \times 1 {0}^{- 9}$$

$${a}_{2} = 6.609 \times 1 {0}^{- 6}$$

$${a}_{1} = 4.058 \times 1 {0}^{- 3}$$

Substituting a₁, a₂, and a₃ into the formula (16) results in the following formula (17).

$$\begin{matrix}[ Formula 11 ] & \\ G ( s ) = \frac{1}{4.634 \times {10}^{- 9} {s}^{3} + 6.609 \times 1 {0}^{- 6} {s}^{2} + 4.058 \times 1 {0}^{- 3} {s}^{1} + 1} & formula ( 17 )\end{matrix}$$

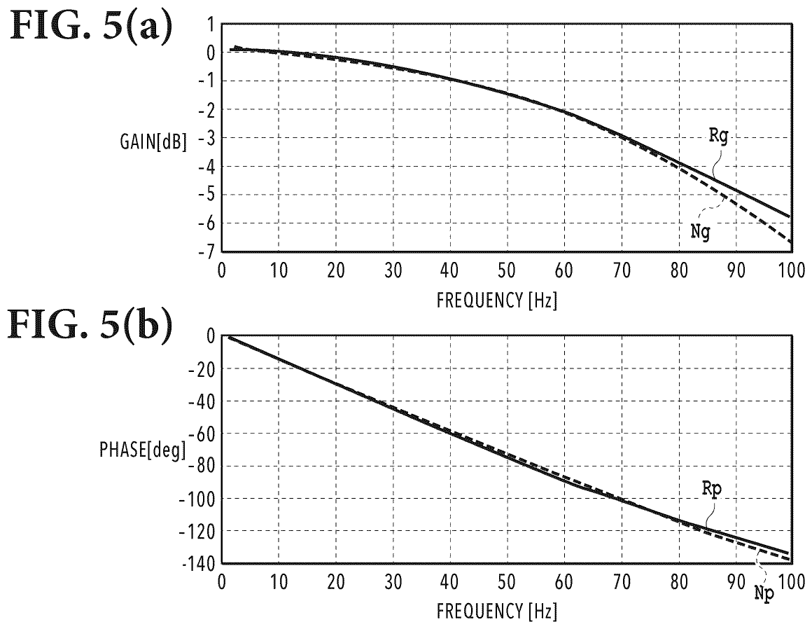

FIGS. 5(a) and 5(b) are Bode diagrams showing transfer functions approximated as the third-order polynomials represented by the above formula (17), showing the gain and the phase for comparison with the gain G and the phase P determined based on the measurement data shown in FIG. 4. Rg and Rp shown in FIGS. 5(a) and 5(b) denotes the gain and the phase obtained by measurement, respectively, and Ng and Np denote the gain and the phase obtained by calculation, respectively. As shown in FIGS. 5(a) and 5(b), at 100 Hz, the error in gain is on the order of 1 dB and the error in phase is within 5 deg, and the accuracy is adequate for simulation of the absorber. Depending on the system, the accuracy may be inadequate. In such a case, the value of n can be increased, and the approximation can be achieved by the same calculation.

### (Factorization of Transfer Function)

Referring back to FIG. 3, in step S103, the transfer function determined in step S102 is resolved into a second-order oscillatory component and a first-order lag component. This is intended to clarify the effect of each component in the determination of an inverse transfer function (step S104). The first-order lag component is expressed by the following formula (18).

$$\begin{matrix}[ Formula 12 ] & \\ G ( s ) = \frac{1}{s / {ω}_{a} + 1} & formula ( 18 )\end{matrix}$$

The second-order oscillatory component is expressed by the following formula (19), in which the solution of the quadratic equation in the denominator is a complex number when ζ<1 and a product of two first-order lag systems when ζ≥1.

$$\begin{matrix}[ Formula 13 ] & \\ G ( s ) = \frac{1}{{( s / {ω}_{b} )}^{2} + 2 ζ ( s / {ω}_{b} ) + 1} & formula ( 19 )\end{matrix}$$

Thus, the transfer function expressed by the formula (2) can be transformed into the formula (20).

$$\begin{matrix}[ Formula 14 ] & \\ & formula ( 20 )\end{matrix}$$

$$G ( s ) = \frac{1}{{a}_{n} {s}^{n} + {a}_{n - 1} {s}^{n - 1} + … + {a}_{1} {s}^{1} + 1} = \frac{1}{{\prod }_{k} ( {( s / {ω}_{k} )}^{2} + 2 ζ ( s / {ω}_{k} ) + 1 ) {\prod }_{m} ( s / {ω}_{m} + 1 )}$$

By solving the following formula (21), coefficients in the factorization can be determined.

$${a}_{n} {s}^{n} + {a}_{n - 1} {s}^{n - 1} + … + {a}_{1} {s}^{1} + 1 = 0 \qquad formula ( 21 )$$

Among the solutions, two solutions that are complex numbers are conjugate and therefore are second-order oscillatory components. Specifically, the solutions are expressed by the following formulas.

$$\begin{matrix}[ Formula 15 ] & \\ {s}_{1} = {ζω}_{k} + j \sqrt{1 - {ζ}^{2}} {ω}_{k} & formula ( 22 )\end{matrix}$$

$$\begin{matrix}[ Formula 16 ] & \\ {s}_{2} = {ζω}_{k} + j \sqrt{1 - {ζ}^{2}} {ω}_{k} & formula ( 23 )\end{matrix}$$

From the formulas (22) and (23), the following relationships are determined.

$$\begin{matrix}[ Formula 17 ] & \\ {s}_{1} \times {s}_{2} = {ω}_{k}^{2} & \end{matrix}$$

$${s}_{1} + {s}_{2} = 2 ζ {ω}_{k}$$

$$\begin{matrix}[ Formula 18 ] & \\ {ω}_{k} = \sqrt{{s}_{1} \times {s}_{2}} & \end{matrix}$$

$$\begin{matrix}[ Formula 19 ] & \\ ζ = \frac{{s}_{1} + {s}_{2}}{2 {ω}_{k}} & \end{matrix}$$

In the example of the formula (17), by solving the denominator.

$$4.634 \times {10}^{- 9} {s}^{3} + 6.609 \times 1 {0}^{- 6} {s}^{2} + 4.058 \times {10}^{- 3} {s}^{1} + 1 = 0 ,$$

the following solutions result.

$${s}_{1} = 439.95 + j 448 \text{.84}$$

$${s}_{2} = 439 \text{.95} - j 448.84$$

$${s}_{3} = 546.3$$

s₁ and s₂ are conjugate and therefore form a second-order oscillatory component.

$$\begin{matrix}[ Formula 20 ] & \\ {ω}_{1} = \sqrt{{( - 439.95 )}^{2} + {( 448.84 )}^{2}} = 628.5 rad / s … ( 100 Hz ) & \end{matrix}$$

$$\begin{matrix}[ Formula 21 ] & \\ ζ = \frac{439.95 + 439.95}{2 \times 628.5} = 0.7 & \end{matrix}$$

$${ω}_{2} = {s}_{3} = 546.3 rad / s … ( 87 Hz )$$

$${ω}_{2} = {s}_{3} = 546.3 rad / s … ( 87 Hz )$$

From the above results, the formula (17) can be rewritten as follows.

$$\begin{matrix}[ Formula 22 ] & \\ & formula ( 24 )\end{matrix}$$

$$\begin{matrix}G ( s ) = \frac{1}{4.634 \times {10}^{- 9} {s}^{3} + 6.609 \times {10}^{- 6} {s}^{2} + 4.058 \times {10}^{- 3} {s}^{1} + 1} \\ = \frac{1}{( {( s / 628.5 )}^{2} + 2 \times 0.7 ( s / 628.5 ) + 1 ) ( s / 546.3 + 1 )}\end{matrix}$$

Referring back to FIG. 3 again, in step S104, a proper inverse transfer function is determined based on the transfer function resolved as described above. Although, in general, an inverse of the determined transfer function is an inverse transfer function, the inverse transfer function is not proper. In that case, real-time calculation cannot be performed, the lag due to the inverse transfer function cannot be corrected, and therefore, accurate HILS simulation cannot be performed. In order to determine a proper inverse transfer function, the denominator has to include a term in which the order of s is equal to or higher than the order of s in the numerator. That is, a proper transfer function means a transfer function that satisfies a condition: the order of s in the numerator ≤the order of s in the denominator. In this embodiment, considering the calculation amount and the calculation capacity, the denominator includes a term in which the order of s is the same as the order of s in the numerator.

In this embodiment, if the formula (24) is substituted with G(s)=1/(((s/ω₁)²+2ζ(s/ω₁)+1)·(s/ω₂)), a proper transfer function whose denominator includes a term of s³ that has the same order as s in the numerator is expressed by the following formula (25).

$$\begin{matrix}[ Formula 23 ] & \\ & formula ( 25 )\end{matrix}$$

$${G}_{inv} ( s ) = \frac{( {( s / {ω}_{b 1} )}^{2} + 2 {ζ}_{b} ( s / {ω}_{b 1} ) + 1 ) ( s / {ω}_{b 2} + 1 )}{( {( s / {ω}_{a 1} )}^{2} + 2 {ζ}_{a} ( s / {ω}_{a 1} ) + 1 ) ( s / {ω}_{a 2} + 1 )} = \frac{{b}_{0} {s}^{3} + {b}_{1} {s}^{2} + {b}_{2} s + C}{{s}^{3} + {a}_{1} {s}^{2} + {a}_{2} s + C}$$

The formula (25) includes parameters ωₐ₁, ωₐ₂, ω_{b1}, ω_{b2}, ζₐ, and ζ_{b}. In this embodiment, by adjusting these parameters, the proper inverse transfer function of the formula (25) is determined so as to come closer to the inverse transfer characteristics of the transfer function of the test system while considering the effects of the first-order lag component (low-pass filter) and the second-order oscillatory component. Each parameter may be manually or automatically determined. The following are example conditions for determining the parameters.
(1) With regard to the denominator of the formula (25), in order to reduce the effect of the phase lag, the frequencies ωₐ₁ and ωₐ₂ are four or more times ω₁ and ω₂ or the maximum frequency that can be simulated by the computing device.
(2) With regard to the denominator, again, in order to reduce the effect of the phase lag, ζₐ is equal to or less than 0.2.
(3) With regard to the numerator of the formula (25), the phase lags to some extent and the gain decreases because of the second-order term and the first-order term in the denominator. Therefore, ω_{b1} and ω_{b2} are set to be smaller than ω₁ and ω₂.
(4) The parameters are adjusted as described above, and a Bode diagram (frequency characteristics of the gain and the phase) of the inverse transfer function including these parameters is determined. And the adjustment described above is repeated until the difference between the determined gain and the required gain falls within 3 dB, and the difference between the determined phase and the required phase falls within 10 deg. Here, the “required gain or phase” means the frequency characteristics of the gain and the phase expressed by the inverse transfer function (referred to as a “theoretical inverse transfer function”, hereinafter) of the transfer function determined as the formula (24).

The settings described above are provided as a general guideline and are not intended to limit this embodiment to the parameter adjustment according to such procedures or settings.

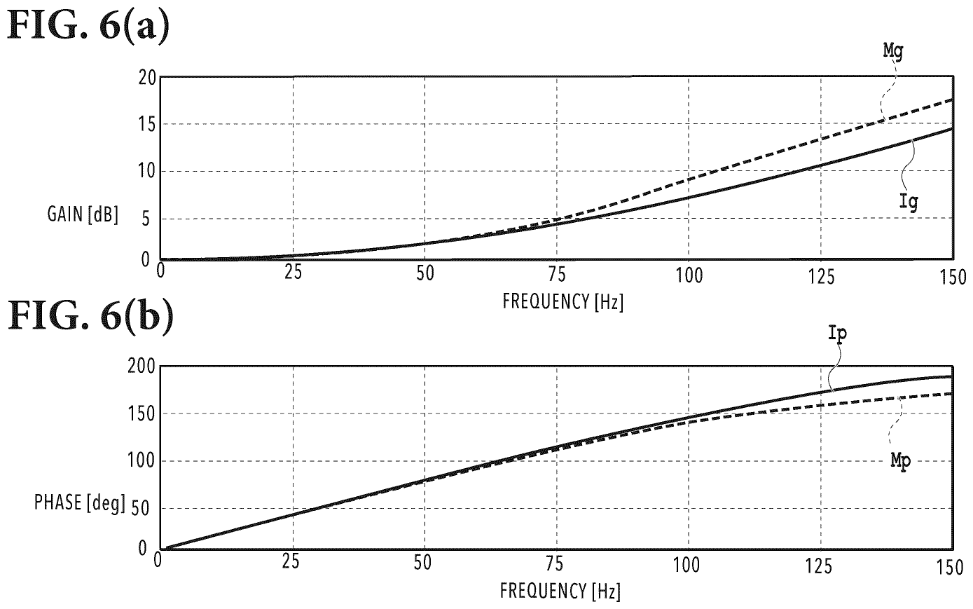

FIGS. 6(a) and 6(b) are Bode diagrams showing the inverse transfer functions determined in this embodiment for comparison with theoretical inverse transfer functions. FIG. 6(a) shows frequency characteristics of the gain (dB), and FIG. 6(b) shows frequency characteristics of the phase (deg). Curves Ig and Ip in FIGS. 6(a) and 6(b) show the gain and phase of a theoretical inverse transfer function, respectively, and curves Mg and Mp show the gain and phase of the inverse transfer function determined in this embodiment, respectively. With regard to the frequency characteristics of the determined gain and phase, as described above, the difference in gain from the theoretical inverse transfer function falls within 3 dB, and the difference in phase from the theoretical inverse transfer function falls within 10 deg. Thus, the response lag (phase lag) in the test system in this embodiment is adequately reduced.

The allowable errors in gain and phase described here are those for the absorber according to this embodiment and do not hold true for all systems. The allowable errors vary with the characteristic frequency range of the system to be evaluated.

In this embodiment, by increasing the parameters ωₐ₁ and ωₐ₂ as far as possible, parameters ω_{b1}, ζ_{b} and ω_{b2} can be brought closer to the parameters ω₁, ζ₁ and ω₂, and the inverse transfer function can be brought closer to the theoretical inverse transfer function at higher frequencies. In this case, it is required to perform calculation with a shorter sampling time, which means that the computing device or controller is required to have higher performance. When the frequency range of the system to be evaluated by HILS is low, adequate matching is achieved at lower frequencies, so that the parameters ωₐ₁ and ωₐ₂ can be decreased, thereby reduce the calculation load and enabling an inexpensive evaluation system to be built.

Table 3 shows the parameters ω₁, ω₂ and ζ₁ of the theoretical inverse transfer function and the parameters ωₐ₁, ωₐ₂, ω_{b1}, ω_{b2}, ζₐ and ζ_{b} of the inverse transfer function generated by approximation.

TABLE 3

| | | |
|---|---|---|
| ω₁ | 628.5 rad/s (100 Hz) | theoretical inverse |
| ζ₁ | 0.7 | transfer function |
| ω₂ | 546.3 rad/s (87 Hz) | |
| ω_{b1} | 534.07 rad/s (85 Hz) | |
| ζ_{b} | 0.7 | proper inverse transfer |
| ω_{b2} | 534.07 rad/s (85 Hz) | function generated by |
| ωₐ₁ | 2513.3 rad/s (400 Hz) | approximation |
| ζₐ | 0.1445 | |
| ωₐ₂ | 2513.3 rad/s (400 Hz) | |

(Evaluation with Inverse Transfer Function)

Referring back to FIG. 3 again, once the proper inverse transfer function is determined, in step S105, the inverse transfer function is implemented in the test system 1 as shown in FIG. 1(b). Note that the inverse transfer function may be implemented in the computing device as with the case of the model computation or may be implemented in a computing unit (not shown) of the controller 20 for the test piece 40 as a real machine. Note that the inverse transfer function is typically implemented in the component having higher computational capacity.

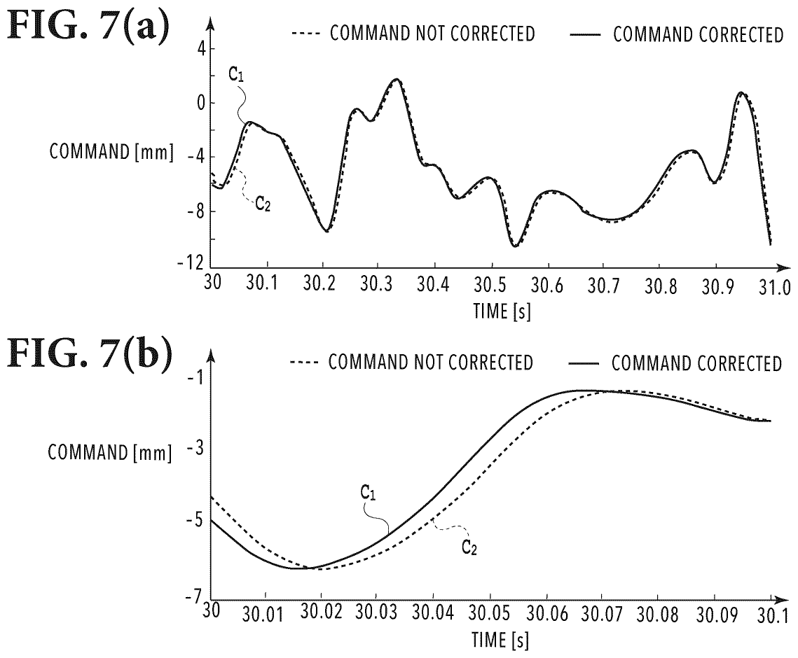

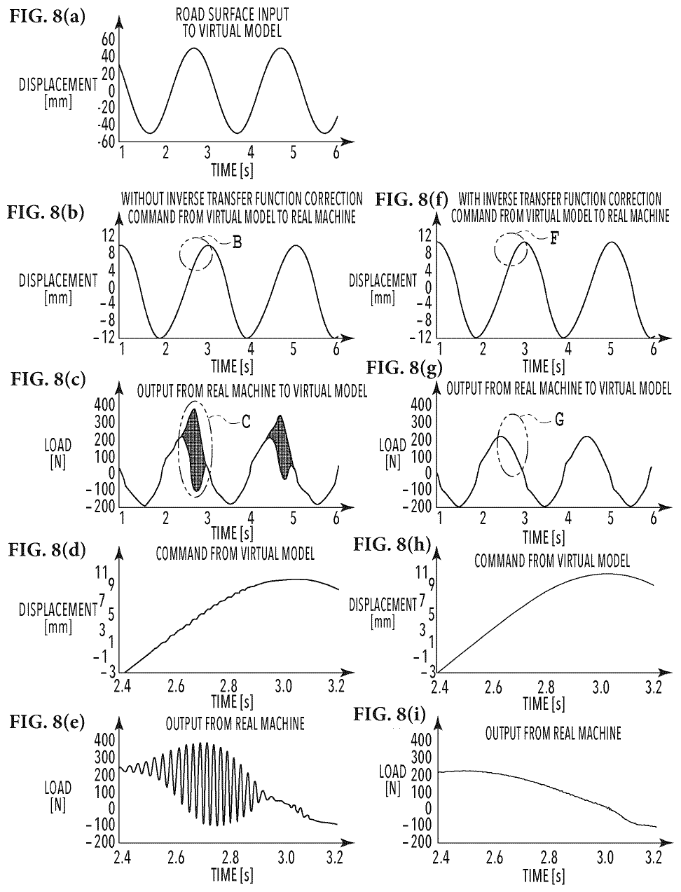

FIGS. 7(a) and 7(b) and FIGS. 8(a) to 8(i) are diagrams for illustrating the effect of the inverse transfer function correcting unit 50 serving as the inverse transfer function in this embodiment. FIG. 7(a) is a diagram showing, for comparison, a signal (command) c2 input to the actuator 30 that is not corrected by the inverse transfer function correcting unit 50 of the test system 100 in FIGS. 1(a) and (b) and a signal (command) c1 input to the actuator 30 having passed through the inverse transfer function correcting unit of the test system 1. FIG. 7(b) is an enlarged diagram showing the signals c1 and c2 in the range from 30 s to 30.1 s on the horizontal axis in FIG. 7(a). In FIGS. 7(a) and 7(b), the horizontal axis indicates the time (s), and the vertical axis indicates the displacement (mm).

A relationship between the lag time and phase of the signal is expressed by the following formula (26) of the phase lag Φ, where F denotes the frequency and δT denotes the lag.

$$Φ = 360 ° \times F \times δ T \qquad formula ( 26 )$$

In the example shown in FIG. 7(a), provided that δT=0.0043 s and F=60 Hz, a lag of Φ=92.8° (approximately a quarter of the period) (which means the time required for the signal Sf₂ output from the test piece 40 to be input to the computing device 10) occurs, and accurate simulation cannot be performed. In this embodiment, as shown in FIG. 7(b), the signal c1 changes in displacement at an earlier timing than the signal c2 (the signal c1 is advanced with respect to the signal c2). According to this embodiment, since the signal c1 is advanced, the signals Sf₁ and Sf₂ output from the test piece 40 are also advanced, and the lag of the signal in the computing device 10 is eliminated, so that accurate simulation can be performed.

FIG. 8(a) is a diagram showing a signal S₀ that indicates a displacement input to the virtual model 11 in FIGS. 1(a) and 1(b) from the road surface Z shown in FIG. 2. FIG. 8(b) is a diagram showing a signal S₁ that is input to the load device 60 from the test system 100, FIG. 8(c) is a diagram showing a signal Sf₂ that is fed back to the virtual model 11 from the test piece 40 of the test system 100, FIG. 8(d) is an enlarged diagram showing the region B in FIG. 8(b), and FIG. 8(e) is an enlarged diagram showing the region C in FIG. 8(c). In FIGS. 8(a) to 8(e), the horizontal axis indicates the time. In FIGS. 8(a), 8(b) and 8(d), the vertical axis indicates the displacement. In FIGS. 8(c) and 8(e), the vertical axis indicates the load.

FIG. 8(f) is a diagram showing a signal S₁ that is input to the load device 60 from the test system 1, FIG. 8(g) is a diagram showing a signal Sf₂ that is fed back to the virtual model 11 from the test piece 40 of the test system 1, and FIG. 8(h) is an enlarged diagram showing the region F in FIG. 8(f), and FIG. 8(i) is an enlarged diagram showing the region G in FIG. 8(g). In FIGS. 8(f) to 8(i), the horizontal axis indicates the time. In FIGS. 8(f) and 8(h), the vertical axis indicates the displacement. In FIGS. 8(g) and 8(i), the vertical axis indicates the load. That is, FIGS. 8(b) to 8(e) show results obtained with the test system 100 in FIG. 1(a) that are not corrected by the inverse transfer function correcting unit 50. FIGS. 8(f) to 8(i) show results obtained with the test system 1 that are corrected by the inverse transfer function correcting unit 50.

In this embodiment, a road surface input to the virtual model 11 is obtained from a simulation road surface having irregularities of +50 mm and sinusoidally changes along the travel direction of the vehicle as shown in FIG. 8(a). The road surface input varies with a cycle of 0.5 Hz at the simulation vehicle speed.

In this test, a real shock absorber is used as the test piece 40. As shown in FIGS. 8(b) and 8(f), although the road surface input is sinusoidal, and the absorber displacement input to the real machine also smoothly changes in an approximately sinusoidal manner, the slope of the absorber load change is discontinuous, has an intense nonlinearity and includes high frequency components. This load signal is fed back to the model (the parts shown as the regions B and F in the drawings).

As shown in FIGS. 8(b) to 8(c), when the correction with the inverse transfer function is not performed, in the regions B and C in FIGS. 8(b) and 8(c) or in the time range from 2.4 s to 3.0 s in FIGS. 8(d) and 8(c), the effect of a high frequency component at nearly 40 Hz gradually increases, and an unwanted oscillation of a high frequency component is superimposed on the command to the real machine calculated on the model. This oscillatory command causes the shock absorber A to oscillate at a high frequency and causes the load signal to the virtual model 11 to be oscillatory. This is because of the erroneous calculation result due to the phase lag of the high frequency component in the load signal described above. To the contrary, as shown in FIGS. 8(f) to 8(i), when the correction with the inverse transfer function is performed, the oscillation described above does not occur, and correct HILS evaluation can be achieved. In this embodiment, since it is known that the oscillation described above does not occur, any such oscillation occurring during traveling of a real vehicle can be recognized as a simulation error. However, in the case of a new product whose characteristics are not known, the absence of the correction with the inverse transfer function leads to an erroneous result.

Note that the timing, frequency or magnitude of the oscillation described above varies with the test conditions, the test piece or the characteristics of the load device. In other words, the oscillation is caused by a change in frequency phase and amplitude of the load component. Therefore, although the oscillation frequency and time are included in the regions B and C in the example shown in FIGS. 8(b) and 8(c), this embodiment is not limited to this example, and the oscillation frequency and time (timing) vary with the test conditions.

Here, the proper transfer function is a transfer function that is strictly realizable in the real world or more specifically a transfer function that satisfies a condition that the order of s in the numerator ≤the order of s in the denominator. That is, a non-proper transfer function can be divided into a proper term and a non-proper term. The output of the test system can be obtained by developing the transfer function. When the transfer function is not proper, the output includes a time derivative of the input because of the effect of the non-proper term. The time derivative is a factor in inhibiting the realization in the real world. As described above, in this embodiment, the output signal of the virtual model 11 is corrected with an inverse transfer function of a proper transfer function, that is, a proper inverse transfer function. Therefore, according to this embodiment, the response lag in the test system caused by the actuator 30 and the like can be eliminated, and the test system 1 can perform simulation with higher accuracy.

A first aspect of the present invention described above is a test system including: a test piece as a part of a real machine that is to be tested; an actuator that actuates the test piece; a virtual model that operates in association with the test piece; a controller that controls the actuator; a computing device that computes the virtual model; and an inverse transfer function correcting unit that corrects a signal from the virtual model with a proper inverse transfer function that is determined based on a transfer function of a system including communication units between the test piece and the actuator and between the actuator and the controller and a communication unit between the computing device and the controller, in which the controller controls the actuator based on the signal corrected by the inverse transfer function correcting unit.

A second aspect of the present invention is the test system according to the aspect described above, in which the inverse transfer function correcting unit is implemented in the computing device.

A third aspect of the present invention is the test system according to the aspect described above, in which the inverse transfer function correcting unit is implemented in a real-machine controlling computing unit that actuates the test piece.

A fourth aspect of the present invention is the test system according to the aspect described above, in which the transfer function is an approximated transfer function in which a numerator is a 0-th order Laplace variable.

A fifth aspect of the present invention is the test system according to the aspect described above, in which the transfer function is an approximated transfer function in which a denominator is a third-order Laplace variable.

A sixth aspect of the present invention is a control method for a test system, the test system including a test piece as a part of a real machine that is to be tested, an actuator that actuates the test piece, a virtual model that operates in association with the test piece, a controller that controls the actuator, and a computing device that computes the virtual model, the control method including: a step of correcting a signal from the virtual model with a proper inverse transfer function that is determined based on a transfer function of a system including communication units between the test piece and the actuator and between the actuator and the controller and a communication unit between the computing device and the controller; and a step of controlling the actuator based on the signal corrected in the inverse transfer function correcting step.

A seventh aspect of the present invention is the control method for a test system described above, in which a transfer function of a system including the actuator and the test piece is divided into a real part and an imaginary part, and the transfer function is determined according to an approximation based on a least squares method.

An eighth aspect of the present invention is the control method for a test system described above, in which a parameter of an approximated inverse transfer function is determined by dividing the transfer function into a first-order lag system and a second-order oscillatory system.

### REFERENCE SIGNS LIST

1, 100 test system
10 computing device
11 virtual model
20 controller
21 comparison unit
22 control unit
30 actuator
40 test piece
50 inverse transfer function correcting unit
60 load device
A shock absorber

1. A test system comprising:
an actuator that actuates a test piece;
a virtual model that operates in association with the test piece;
a controller that controls the actuator;
a computing device that computes the virtual model; and
an inverse transfer function correcting unit that corrects a signal from the virtual model with a proper inverse transfer function that is determined based on a transfer function of a system including communication units between the test piece and the actuator and between the actuator and the controller and a communication unit between the computing device and the controller,
wherein the controller controls the actuator based on the signal corrected by the inverse transfer function correcting unit, and
wherein the proper inverse transfer function is an inverse transfer function where the order of the numerator is less than or equal to the order of the denominator.

2. The test system according to claim 1, wherein the inverse transfer function correcting unit is implemented in the computing device.

3. The test system according to claim 1, wherein the inverse transfer function correcting unit is implemented in a real-machine controlling computing unit that actuates the test piece.

4. The test system according to claim 1, wherein the transfer function is an approximated transfer function in which a numerator is a 0-th order Laplace variable.

5. The test system according to claim 4, wherein the transfer function is an approximated transfer function in which a denominator is a third-order Laplace variable.

6. A method for controlling a test system, the test system including an actuator that actuates a test piece, a virtual model that operates in association with the test piece, a controller that controls the actuator, and a computing device that computes the virtual model, the method comprising:
an inverse transfer function correcting step of correcting a signal from the virtual model with a proper inverse transfer function that is determined based on a transfer function of a system including communication units between the test piece and the actuator and between the actuator and the controller and a communication unit between the computing device and the controller; and
a step of controlling the actuator based on the signal corrected in the inverse transfer function correcting step,
wherein the proper inverse transfer function is an inverse transfer function where the order of the numerator is less than or equal to the order of the denominator.

7. The method for controlling a test system according to claim 6, wherein a transfer function of a system including the actuator and the test piece is divided into a real part and an imaginary part, and the transfer function is determined according to an approximation based on a least squares method.

8. The method for controlling a test system according to claim 6, wherein a parameter of an approximated inverse transfer function is determined by dividing the transfer function into a first-order lag system and a second-order oscillatory system.
